(19) United States
(12) Patent Application Publication
(10) Pub. No.: US 2014/0333432 A1
(43) Pub. Date: Nov. 13, 2014

(54) SYSTEMS AND METHODS FOR WORKER LOCATION AND SAFETY CONFIRMATION

(71) Applicant: Cartasite, Inc., Denver, CO (US)

(72) Inventor: David L. Armitage, Golden, CO (US)

(73) Assignee: Cartasite, Inc., Denver, CO (US)

(21) Appl. No.: 14/270,616

(22) Filed: May 6, 2014

Related U.S. Application Data
(60) Provisional application No. 61/820,289, filed on May 7, 2013.

(51) Int. Cl. G08B 27/00

(52) U.S. Cl. CPC G08B 27/00
USPC 340/539.11

(57) ABSTRACT

Systems, methods, and software are provided herein for worker location and/or safety confirmation. In at least one example, a user will carry a user device which include monitoring functionality. This device will monitor for concerning event such as an unexpected location, a lack of user movement, a press of an emergency button, over time, or time out condition, or any other indication of a concerning event. If an alert associated with the event is not acknowledged by the user, the user device may transmit an alert to a user station and/or a network. In turn, the user station and/or network will transmit an alert to a remote station regarding the status of the user device.

### CROSS REFERENCE TO RELATED APPLICATIONS

This application claims priority to, and benefit from, provisional patent application Ser. No. 61/820,289, entitled “SYSTEMS AND METHODS FOR WORKER LOCATION AND SAFETY CONFIRMATION,” filed May 7, 2013, which is incorporated by reference for all purposes.

### BACKGROUND

Global communication safety systems are designed to keep users connected and safe from anywhere on the planet. Many workers work alone, and may work in hazardous or non-hazardous locations and situations. Workers should also be in a work area during work hours.

Furthermore, hazardous locations exist where safety monitoring is a high priority and electronics in these locations are tightly controlled. Examples of hazardous locations include those classified as Class 1, Class 2, and Class 3 by the National Electric Code. Class 1 locations include petroleum refineries, gasoline storage, utility gas plants, and any other location with the presence of flammable gases or vapors. Further, the classes are divided into Division 1 locations and Division 2 locations. Division 1 locations are locations where the hazardous material would normally be present, whereas Division 2 locations are locations where the hazardous material would not normally be present.

### OVERVIEW

Methods, systems, and software for worker location and/or safety confirmation are disclosed. Workers may also have the option of checking in, and/or being tracked. The methods, systems, and software may include receiving an indication to monitor a device, receiving information about the device, determining if a concerning event exists based at least in part on the information about the device, and providing a notification of the concerning event.

The methods, systems, and software may include monitoring a user device for a concerning event, notifying the user of the concerning event, receiving a recognition from the user, and if the alert is not recognized, sending an notification to a remote station.

### BRIEF DESCRIPTION OF THE DRAWINGS

FIG. 1 illustrates a system for worker location and/or safety confirmation according to an example.

FIG. 2 illustrates a system for worker location and/or safety confirmation according to an example.

FIG. 3 illustrates a flowchart for operating a user device for worker location and/or safety confirmation according to an example.

FIG. 4 illustrates a flowchart for operating a user station for worker location and/or safety confirmation according to an example.

FIG. 5 illustrates a system for worker location and/or safety confirmation according to an example.

FIG. 6 illustrates a user interface of a monitored user device according to an example.

FIG. 7 illustrates a user interface of a remote or user station according to an example.

### DESCRIPTION

Methods, systems, and software are provided herein for worker location and/or safety confirmation. In at least one example, a user will carry a user device which include the functionality to be monitored. This device will monitor for concerning event such as an unexpected location, a lack of user movement, a press of an emergency button, over time condition, rapid acceleration/deceleration event, or time out condition, or any other indication of a concerning event. Once a concerning event is detected, the user device may transmit an notification to a user station and/or a network. In turn, the user station and/or network will transmit the notification to a remote station regarding the status of the user device.

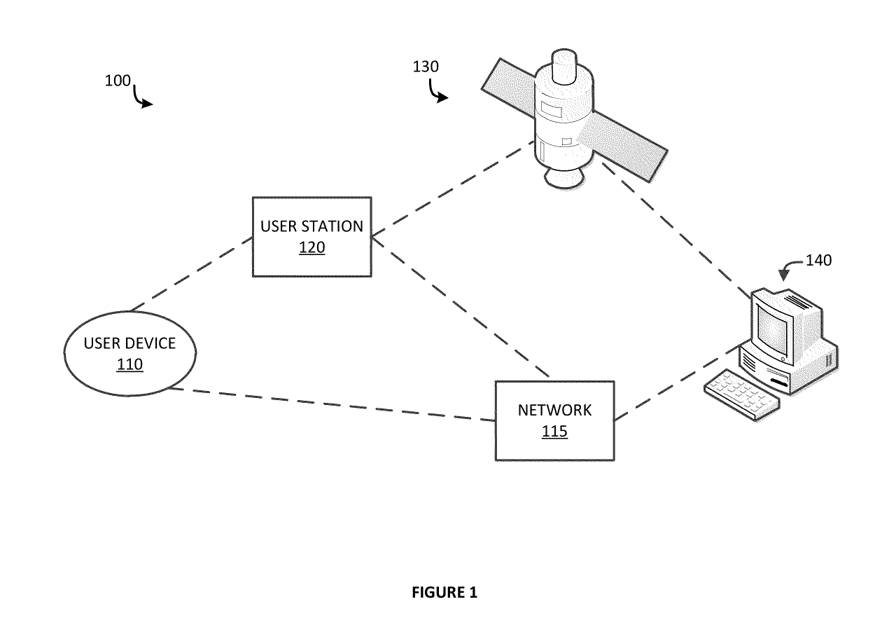

FIG. 1 illustrates a worker location and/or safety confirmation system 100 according to one example. System 100 includes user device 110, network 115, user station 120, satellite(s) 130, and remote station 140.

User device 110 is connected to user station 120 via a Bluetooth, Wi-Fi, near field, or other form of wireless communication. In turn, user station 120 is connected to remote station 140 via satellite(s) 130. User device 100 may be connected to network 115 via cellular communication, Bluetooth, Wi-Fi, RF, or other form of wireless communication. Network 115 may be connected to remote station 140 via a cellular connection, network, communication system, and/or the Internet.

User device 110 can be any device capable of being carried by a user and operating in the manner described herein. User device 110 can be configured to monitor for concerning events such as an unexpected location, a lack of user movement, a press of an emergency button, over time condition, or time out condition, or any other indication of a concerning event, or any other form of concerning event including combinations thereof. Further, user device 110 can be configured to transmit an notification to network 115 and/or user station 120 upon indication of a concerning event and can be configured to receive alerts and/or notifications from user station 120 and/or remote station 140.

User station 120 can be any device capable of receiving alerts/notifications from user device 110, and capable of sending alerts/notifications to remote station 140. In one example, user station 120 can also be configured to receive alerts from remote station 140, and send alerts to user device 110. Similarly, Network 115 can be any device and/or system capable of receiving alerts and/or communications from user device 110, and capable of sending alerts/notifications to remote station 140. Furthermore, network 115 can also be configured to receive alerts from remote station 140, and send alerts to user device 110.

Satellite(s) 130 can include one or more satellites capable of communicating alerts/notifications between user station 120 and remote station 140.

Remote station 140 can be any device capable of receiving alerts/notifications from user station 120 and device 110. Remote station may include a server computer, desktop computer, a tablet computer, a telephone, or any other device capable of receiving alerts and/or communications from user station 120 and/or network 115.

In one example, remote station 140 can transmit the alert/notification from user station 120 to other devices such as other server computers, desktop computers, tablet computers, telephones, or the like. In one example, remote station 140 can be configured to transmit an alert to user station 120, which may be forwarded to user device 110.

If a concerning event exists, device 110 may try to communicate an alert via a cellular call or alert via network 115. If unable to communication via a cellular call or alert, device may try to communicate via a short message service (SMS) or other message service via network 115. Device may also try to communicate via any other method using network 115.

If device is unable to communication via network 115, device may try to communicate via user station 120 via Bluetooth or other method or protocol. User device 120 may then use a satellite network 130 to communicate with remote station 140.

In an example, device 110 may be a smart phone with an application capable of operating as described herein. Device may try to communication via cellular, the messaging, Internet or other type of communication via network 115 to remote station 140.

Then device 110 may try to communicate with user station 130 via Bluetooth or other type of communication. User device 120 may then communicate via satellite network 130 to remote station 140.

In an example, user device 110 may be a personal communication device, such as a cell phone. The user may be remote, alone or may want to be monitored. The user may activate an application on user device 110, which will use the accelerometer, GPS, gyroscope, and other functionality to monitor the movement/activities of the user.

According to an algorithm, the application may determine a concerning event has occurred, such as the user not moving for a period of time. This may be an indication the user has passed out or been hurt. The application may then provide an alert to the user. If the user acknowledges the alert, the application may return to monitoring for a concerning event.

If the alert is not acknowledged, the application may use various communication channels to contact/notify a supervisor, another worker in the area, emergency personnel, call 911, etc.

User station 120 may be used when the user device 110 is unable to use network 115. This may be when user device is out of range 230 of network 115. User station 220 may be capable of receiving communication from user device 110, such as Bluetooth, and then communicating with satellite network 130 or network 115. In an example, user station 120 may be a device adjacent a vehicle, and may be powered by the OBD port of the vehicle.

In hazardous locations, Wi-Fi and other communication type may not be able to be used. If user station 220 is within user device range 230, but outside of safety zone 250 (hazardous location), then user device 210 may communicate with user station 220, and user station 220 may communicate with various methods and protocol through networks 215 130 to send notifications.

The application may reside partially or wholly on the various computing systems described herein.

User station 110 210 may include sensors to gather information about the vehicle form the OBD port, CAN bus, and from other devices such as a global position system (GPS) receiver. User station 110 210 may also include memory (such as flash memory), a processor, a real-time operating system, Bluetooth-type communication capabilities, global positioning system capabilities, satellite communication capability and/or cellular communication capabilities.

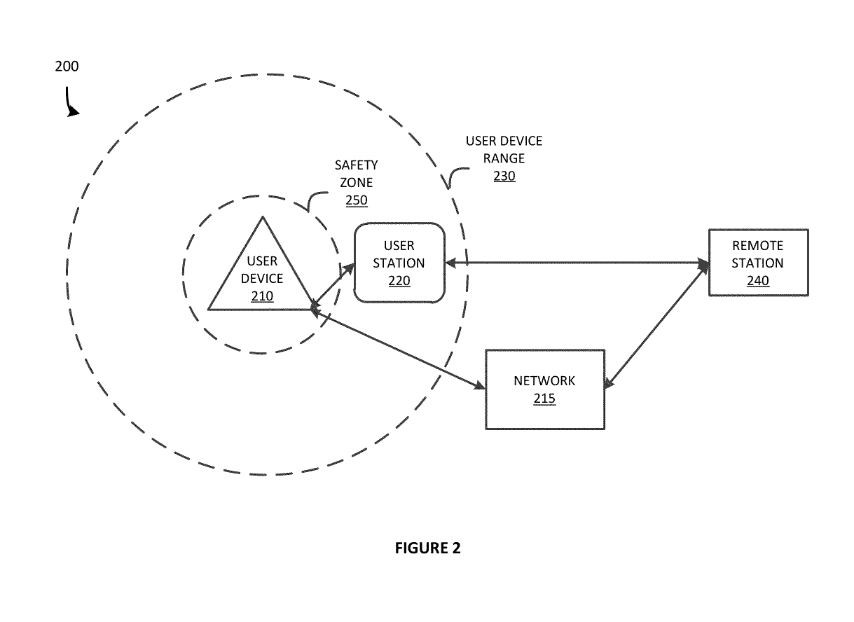

FIG. 2 illustrates a global communication system 200 capable of worker location and/or safety confirmation according to an example. In this example, the worker may be working in a hazardous location or safety zone 250. System 200 includes user device 210, network 215, user station 220, and remote station 230.

User device 210 is connected to user station 220 via a Bluetooth, Wi-Fi, or other form of wired or wireless communication. In turn, user station 220 is connected to remote station 230 via satellite communication network, Internet, or any other communication network including combinations thereof.

Similarly, user device 210 is connected to network 215 via cellular, Bluetooth, Wi-Fi, or other form of wireless communication. In turn, network 115 is connected to remote station 230 via communication network 215, Internet network, or any other communication network including combinations thereof.

User device 210 can be any device capable being carried by a user and entering safety zone 250. Safety zone 250 may consist of a Class 1/Division 1 location or any other hazardous electrical or other location. Additionally, user device 210 can be configured to monitor for concerning events such as lack of movement from the user, a user actuating a button or a switch, rapid acceleration/deceleration, GPS location, or any other form of concerning event including combinations thereof. Further, user device 210 can be configured to transmit an alert to user station 220 or network 215 upon detection of a concerning event and also, in at least one example, can be configured to receive alerts from user station 220 via user station 220 and/or network 215.

User station 220 can be any device capable of receiving an alert from user device 210 from within the user device range 240, and capable of transmitting a second alert to remote station 230 upon receipt of an alert from user device 210. User station 220 may further be configured to receive alerts from remote station 230 and transmit alerts to user device 210.

Network 215 may include a cellular network and can include any devices or systems capable of receiving an alert from user device 210 from within the range of network 215, and capable of transmitting a second alert to remote station 230 upon receipt of an alert from user device 210. User station 220 may further be configured to receive alerts from remote station 230 and transmit alerts to user device 210 via network 215.

Remote station 230 can be any device capable of receiving alerts from user station 220. These alerts may include the type of concerning event that occurred, the location of the alert, as well as any other information about the status of user device 210 including combinations thereof. Remote station 230 may also be configured to transmit alerts to user station 220 and network 215, which may be forwarded to user device 210.

In an example, a user may activate an application on user device 210 before entering a hazardous location, such as a confined space. If the user fall off a ladder or other higher area, the accelerometer of the user device 210 may indicate a concerning event. The device may provide an alert to the user. If the alert is not acknowledged, user dice 210 may implement a communication to user station 22, or network 215, to remote station 240. Remote station 240 may include a supervision, worker in the area, emergency personnel, 911, etc. With this system a remote worker may be provided with another level of safety.

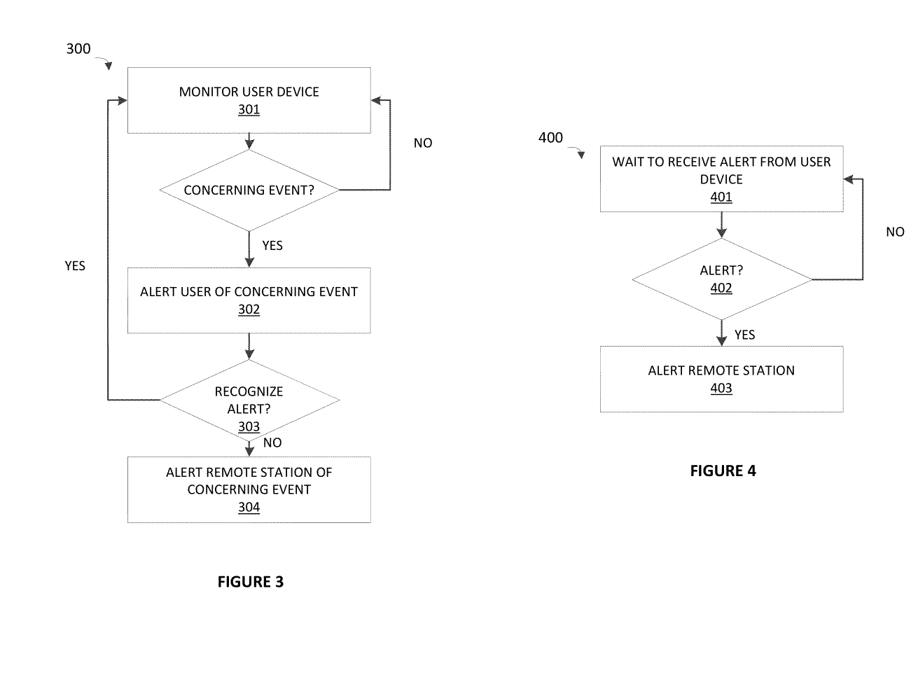

FIG. 3 illustrates a flowchart 300 for operating user device 210 and/or 110 according to one example. The method begins at step 301 by monitoring user device 110 210 for a concerning event. This monitoring could be done using accelerometers, GPS, or user inputs or indications, or any other method of monitoring for a concerning event. If no concerning event has occurred, the system will return to monitoring for a concerning event. However, a concerning event has occurred the system will progress to step 302.

At step 302, user device 210 will alert the user of the concerning event. This first alert may either be audible in the form of a speaker on the device, a vibration, or any other method of notifying the user of a concerning event. The alert may be a cell phone call, SMS, text, alarm, email, etc.

Thereafter, at step 303, the system will determine if the user responded to the alert. The response could include shaking the device to activate the accelerometer, pressing a button, flipping a switch, speaking, or any other form of user interaction to recognize the alert. If the user acknowledges the alert, the system will return to step 301 and monitor for a concerning event. However, if the user does not acknowledge the alert, user device 210, 110 will transmit a second alert to remote station 140, 240 (step 304).

Alerting remote station (304) may include using network 115, 215 to communicate with remote station 140, 240. The communication may include a cellular communication, SMS, email, or other messaging communication, or any other type of communication the devices or systems are capable of.

Alerting remote station (304) may include using user station 120, 220 to communicate with remote station 140, 240 via a satellite system. Device 110, 210 may communication with user station 120, 220. User station 120, 220 may then communicate with network 115, 215, which may then communicate with remote station 140, 240. The communication may include a satellite communication, or any other type of communication the devices are capable of. In another example, user device 110 210 may also communicate with remote station via network 115, 215.

FIG. 4 illustrates a flowchart 400 for operating user station 120, 220 according to one example. The method begins at step 401 by monitoring for an alert from user device 110, 210. If an alert 402 is not present the system will return to step 401. However, if an alert is presented from user device 110, 210, the system will then transmit a second alert to remote station 230 indicating an concerning event at user device 210 (step 403).

The alert could be actuating an “SOS” button on the device 110 210. It also could include the non-acknowledgement of an initial or first alert. This alert could include the type of concerning event that occurred, the location of the alert, as well as any other information about the status of user device 110, 210 including combinations thereof.

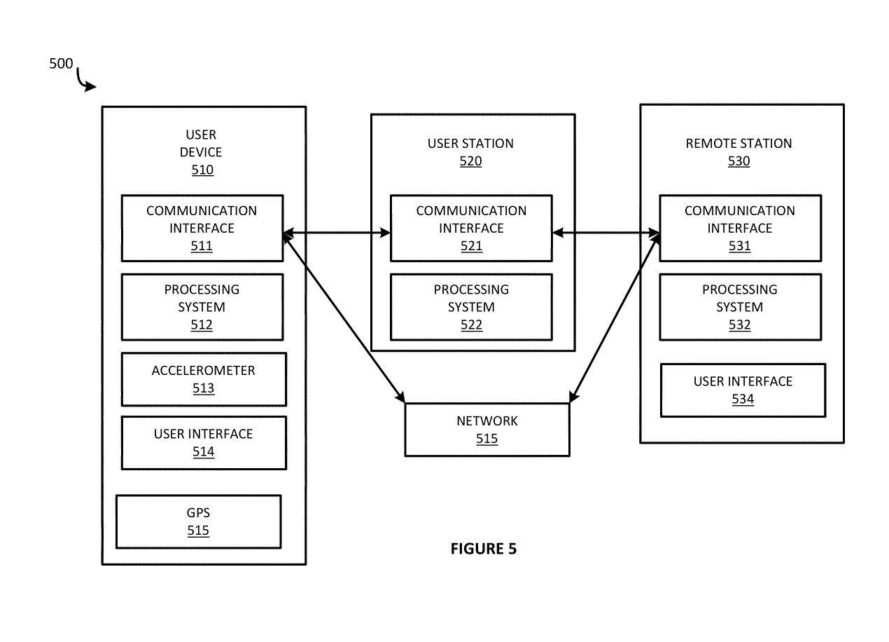

FIG. 5 illustrates a global communication system 500 according to one example. Global communication system 500 comprises user device 510, user station 520, and remote station 530.

User device 510 is connected to user station 520 via a Bluetooth, Wi-Fi, or other form of wired or wireless connection. In turn, user station 520 is connected to remote station 530 via satellite communication network, Internet, other network or communication channel, or any other type of communication including combinations thereof.

In FIG. 5, user device 510 comprises communication interface 511, processing system 512, accelerometer 513, and user interface 514. Processing system 512 is configured to monitor data from accelerometer 513, GPS 515, user interface 514, and other sensors, either internal or external, for concerning events. These concerning events could include an unexpected location, a lack of user movement, a press of an emergency button, over time condition, time out condition, rapid acceleration/deceleration or any other indication of a concerning event. When system 510 determines a concerning event has occurred, system 512 directs communication interface 511 to transmit an alert to user station 520 and/or network 515.

After the transmission of an alert from user device 510, the alert is received at user station 520. User station 520 is configured to monitor for alerts from user device 510 as further described by operation 400. User station 520 includes at least communication interface 521 and processing system 522.

If the first alert is sent to remote station 530 via network 515, the first alert is transmitted to remote station 530. This first alert may include the location of the device, the concerning events that occurred (lack of movement, button press, etc.), or any other information regarding the status of user device 510.

If the alert is sent to remote station 530 via user station 520, upon the receipt of the alert at communication interface 521, user station 520 prepares to send a second alert using communication interface 521 to remote station 530. This second alert may include the location of the device, the concerning events that occurred (lack of movement, button press, etc.), or any other information regarding the status of the user or user device 510. The alert may be the same or different than the first alert from user device 510 to user station 520.

After the alert transmission from user station 520 or via network 515, the alert is received at remote station 530. Remote station 530 can be configured with communication interface 531 and processing system 532. Upon receipt of the alert, processing system 532 can be configured to display the alert, can be configured to transfer the alert to another device such as another server computer, desktop computer, tablet computer, or telephone, can be configured to store the alert, or any other possible action with the alert.

Examples of remote station 530 include server computers, desktop computers, tablet computers, and telephones. In one example, remote station 530 can create an alert that is transferred to user station 520, which may be forwarded to user device 510.

Each of user device 510, user station 520, and remote station 530 can be a computing system which includes processing system, storage system, and software according to an example. Each processing system retrieves and executes software from a storage system (not shown). In some examples, processing system comprises specialized circuitry, and software or storage system could be included in the specialized circuitry to operate processing system as described herein.

Storage system could include a computer-readable medium such as a disk, tape, integrated circuit, server, or some other memory device, and also may be distributed among multiple memory devices.

Software may include an operating system, logs, utilities, drivers, networking software, and other software typically loaded onto a computer system. Software could contain an application program, firmware, or some other form of computer-readable processing instructions. When executed by processing system, software directs processing system to operate as described herein, such as to operate the methods and functionality described herein.

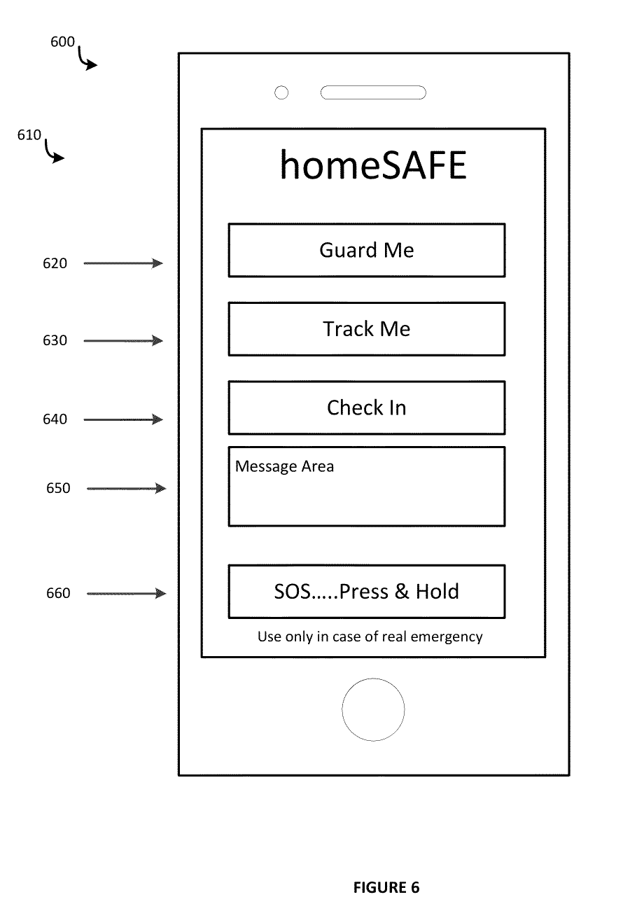

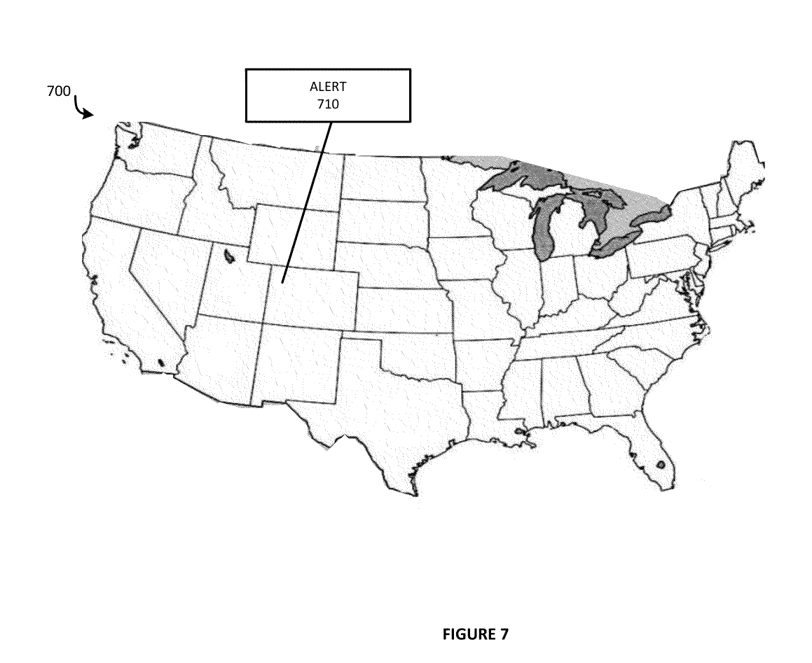

FIG. 6 is a user interface 610 of a user device 600 according to an example. User interface 610 may include actuators or virtual “buttons” in an example.

A “Guard Me” button 620 may be included in an example. When actuated, the Guard Me actuator may cause the user device to start the Guard Me application or mode. In Guard Me mode the user device 600 may monitor various aspect of the user device 600 and other sensors, and may automatically send an notification to the remote station if the accelerometer indicates no movement for a period of two minutes. The device may also first send an alert to the user, which if acknowledged, will restart the timer for the alert to be sent to the remote station.

The user may elect to activate Guard Me mode when the user enters a hazardous area alone. The user may terminate the Guard Me mode after leaving the hazardous zone. This may provide more information to the monitor of the remote station. The monitor of the remote station may be human or automated to contact various entities for safety. This may provide a higher degree of safety than without this functionality.

User interface 610 may also include a “Track Me” actuator 630 which, when actuated, cause the user device 600 to start a Track Me sequence, or enter the Track Me mode. The Track Me mode may use a GPS of the user device to track the movement of the device. The Track Me mode may also track time and route of the user device. A concerning event may be if the user device goes outside a determined area, is stopped for an extended period of time, and/or takes too much time to reach a destination, and/or varies from a predetermined route. This may provide a higher degree of safety than without this functionality.

The Track Me mode may also send your position information every five minutes to predetermined contacts for a time period, such as a user selectable time period. All time periods described herein may be automatically or user selectable, or other. The user may also terminate Track Me mode. This mode may be used when a user is traveling in a storm, or late at night and wants someone or system to be aware of the movements and safety of the user.

User interface 610 may also include a “Check In” actuator 640 which, when actuated, causes the device to send a check in message to the remote station. The message may include information regarding position and other information. The Check In may be used to start a work shift, check in from Guard Me and Track Me modes, as well as for other purposes. The Check In mode may send a message to certain contacts. The contacts may be predetermined or entered by the user, among others.

The Check In/Out mode may be used for work shift, time keeping, billing, work schedules, etc. This may automate time sheets and billing reporting, and may save time, money and accuracy over existing systems.

User interface 610 may also include a message portion 650 for messages to the user from the device and/or from the remote station, among others. The message from the device may include a message about a concerning event alert about to be sent, among others. The message portion also may be capable of receiving automated messages, such as if the user goes outside of a geofence area, or checks in too early for a shift, or has not checked out at the end of a shift. This may increase safety and reporting. If a user is hurt and does not check out after a shift, the system may remind the user to do so. If the user does not acknowledge or does not check out, this may be an indication that the user is in trouble or not safe.

User interface 610 may also include an SOS actuator 660. The user may press (or slide) this actuator to immediately send a message to the remote station of a concerning event. This may provide a higher degree of safety than without this functionality. The SOS may be used when the user is in trouble and needs immediate assistance. A notification may be sent to workers in the area and/or emergency personnel, and/or other persons, entities, monitoring companies, computers, entities, etc.

FIG. 7 may illustrate a remote station 140, 240, 540 user interface 700. User interface 700 may include a map, address, lat long coordinates or other geographic indication. User interface 700 may also include alerts 710 from user device(s) 110, 210, 510. The alert may include the location of the device, the concerning events that occurred (lack of movement, button press, etc.), mode the device is in, type of environment the device is in, or any other information regarding the status of user device 110, 210, 510. This may aid the monitor of remote device with information for getting help to the user. This may provide a higher degree of safety than without this functionality.

Although one alert is shown, many alerts may be shown on the user interface 700.

The user device user interface, and/or the remote station user interface may also include a calendar and scheduling application, which may allow for a user to check in to report to work, and for a supervisor to see worker schedules and location, etc.

Using these systems and methods workers may enter and manage their work schedule using a simple intuitive calendar interface. The user may also extend their shift, with a notification to a supervisor. The systems and methods may be implemented with a smart phone, Internet, cloud, and remote station computer or smart phone.

Each user may be associated with a “geofence”, or predetermined work area which defines the in-field and out-of-field or “homebase” area. An alert may be sent when the user goes outside the area.

The remote station or other server or computer may monitor schedule, accelerometer, mode, and location to determine status. The remote station interface may be implemented on a computer, mobile device, and/or smart phone, among many other devices.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for enhanced safety, comprising:
receiving an indication to monitor a user device;
receiving information associated with the user device;
determining if a concerning event exists based at least in part on the information associated with the user device; and
providing a notification of the concerning event to a remote station.

2. The method of claim 1, further comprising sending an alert to the user device related to the concerning event.

3. The method of claim 2, further comprising receiving and acknowledgement of the alert, and if the acknowledgement is received, not sending the notification.

4. The method of claim 1, wherein the information about the user device comprises a concerning event, wherein the concerning event comprises at least one of: unexpected location, a lack of user movement, a actuation of an emergency button, over time condition, rapid acceleration/deceleration event, or time out condition.

5. The method of claim 1, wherein the notification is provided at least in part using at least one of a satellite network, cellular network, blue-tooth, Wi-Fi, Internet, and RF communication.

6. The method of claim 1, wherein the user device is located in a hazardous location.

7. The method of claim 1, wherein notification is sent at least in part by a user station.

8. The method of claim 7, wherein the user station is associated with a vehicle.

9. A computer program product having instructions, which if executed by a processing system, cause the processing system to enhance worker safety by:
monitoring a user device for a concerning event;
sending an alert to the user device with information regarding a concerning event, if it is determined a concerning event has occurred;
receiving an acknowledgement from the user, and
if the alert is not acknowledged, sending a notification to a remote station.

10. The computer program product of claim 10 having further instructions wherein the concerning event comprises at least one of: unexpected location, a lack of user movement, a actuation of an emergency button, over time condition, rapid acceleration/deceleration event, and time out condition.

11. The computer program product of claim 10 having further instructions wherein the notification is provided at least in part using at least one of a satellite network, cellular network, blue-tooth, Wi-Fi, Internet, and RF communication.

12. The computer program product of claim 10 having further instructions wherein notification is sent at least in part by a user station.

13. The computer program product of claim 10 having further instructions wherein the user station is associated with a vehicle.

14. A system for enhanced worker safety, comprising:
a user device configured to monitor sensors for a concerning event, determine if a concerning event has occurred, send an alert to the user device with information regarding a concerning event, if it is determined a concerning event has occurred; receiving an acknowledgement from the user, and if the alert is not acknowledged, sending a notification to a remote station associated with emergency personnel at least in part via a user station.

15. The system of claim 14, wherein the concerning event comprises at least one of: unexpected location, a lack of user movement, a actuation of an emergency button, over time condition, rapid acceleration/deceleration event, or time out condition.

16. The system of claim 14, wherein the notification is sent at least in part using at least one of a satellite network, cellular network, blue-tooth, near field communication, Wi-Fi, Internet, and RF communication.

17. The system of claim 14, wherein the user station is associated with a vehicle.

18. The system of claim 17, wherein the user device is located in a hazardous location, and the user station is located outside the hazardous location.

19. The system of claim 17, wherein the user station comprises flash memory, a processor, a real-time operating system, Bluetooth-type communication capabilities, global positioning system capabilities, satellite communication capability and/or cellular communication capabilities.

20. The system of claim 14, wherein the monitored sensors comprise sensors in the user station.
